(19) United States
(12) Patent Application Publication
(10) Pub. No.: US 2014/0314553 A1
(43) Pub. Date: Oct. 23, 2014

(54) Method for Manufacturing a Plastic Housing and Plastic Housing

(71) Applicant: MANN+HUMMEL GMBH, Lidwigsburg (DE)

(72) Inventors: Ulrich Dehnen, Kornwestheim (DE); Hedwig Schick, Tamm (DE); Thomas Tschech, Marbach (DE)

(73) Assignee: MANN+HUMMEL GMBH, Ludwigsburg (DE)

(21) Appl. No.: 14/255,198

(22) Filed: Apr. 17, 2014

(30) Foreign Application Priority Data
Apr. 17, 2013 (DE) 10 2013 006 610.7

(51) Int. Cl. F04D 29/40; B29C 65/20; B29C 65/10

(52) U.S. Cl. CPC F04D 29/403; B29C 65/103; B29C 65/20; B29L 2031/30
USPC 415/182.1; 156/60; 156/275.1

(57) ABSTRACT

In a method for manufacturing a plastic housing, in particular a compressor housing, by joining at least two contact surfaces of at least two plastic components, the contact surfaces are joined with each other by a hot gas welding process or by an electromagnetic resistance welding process or by a combination of both.

### CROSS-REFERENCE TO RELATED APPLICATION

This application claims the benefit of German patent application No. 10 2013 006 610.7, filed Apr. 17, 2013, the entire contents of the aforesaid German patent application being incorporated herein by reference.

### BACKGROUND OF THE INVENTION

The invention concerns a method for manufacturing a plastic housing by joining at least two contact surfaces of at least two plastic components. Moreover, the invention concerns a corresponding plastic housing. The plastic housing is in particular a compressor housing of plastic material, in particular for an exhaust gas turbocharger of a motor vehicle.

DE 103 14 209 B3 discloses a radial compressor that is a component of an exhaust gas turbocharger and is comprised of two cup-shaped housing parts that are comprised of thermoset plastic material. The housing parts are glued together which requires a relatively high manufacturing expenditure.

Moreover, it is known to join plastic components with each other by ultrasonic welding. For this purpose, a sonotrode is advanced to the welding zone where welding of the components is to be carried out. When several welded connections are required, for example, in case that more than two individual parts are to be joined, the welded connections are generated sequentially. A problem is however that the vibrations that are caused by ultrasonic welding can lead to damages in the already existing welded connections. Moreover, inhomogeneities in the material or wall thickness steps can lead to fracture formation. In order to avoid this, joining of the components in a single process step would be required. This is however only possible when the welding geometry is simple and within one plane. The sonotrode size limits in this connection the extent of welding.

It is an object of the invention to provide a plastic housing and a method for manufacturing a plastic housing which enables a stable connection of at least two plastic housing components of any shape and size.

### SUMMARY OF THE INVENTION

In the method according to the invention for manufacturing a plastic housing by joining at least two contact surfaces of at least two plastic components, the contact surfaces are joined to each other by a hot gas welding process and/or by an electromagnetic resistance welding process.

In a first embodiment, welding is performed along at least one two-dimensional contour. The contact surfaces which are to be joined with each other by welding are positioned in this context at least approximately in a common plane or adjoin a common plane. In a further embodiment, in addition or as an alternative, welding is performed along at least one three-dimensional contour. The contact surfaces can be located in different planes and, in this context, can have any contour. Even curved contact surfaces are possible.

Advantageously, at least two welded connections are formed in one working step. By hot gas welding or resistance welding, joining of at least two plastic components on at least two different locations is possible in one working step. Different joining zones which may even be in different planes can be welded simultaneously. For example, three or more plastic components can even be joined to each other in one and the same working step.

According to one embodiment, for electromagnetic resistance welding at least one metallic heating element is applied to at least one contact surface or is introduced into at least one contact surface, for example, embedded by injection molding. The metallic heating element is electromagnetically heated as the resistance welding process is performed in a contactless manner so that the two contact surfaces will fuse with each other when the contact surface of a second plastic component is simultaneously or immediately subsequently pressed on.

In one embodiment, the hot gas welding process is carried out with nitrogen. By the use of nitrogen as an inert gas, oxidation of the molten plastic material is prevented or at least minimized.

An advantage of the method according to the invention resides in that loose welding particles are avoided and therefore soiling of the functional surfaces is prevented. In this way, a plastic housing with a high degree of cleanness can be produced. The mechanical loading of the plastic components during the joining process is minimal so that the method is suitable also for joining components of brittle or highly filled plastic materials. Moreover, mechanically sensitive components, for example, sensors, can be mounted prior to the joining process. With the method according to the invention, plastic housing parts with complex geometry can also be produced because welding along two-dimensional and/or three-dimensional contours is possible.

The invention is furthermore solved with regard to a plastic housing in that the plastic housing is produced by the afore described method. In an embodiment, the plastic housing is embodied as a compressor housing for a turbocharger. A compressor housing has to absorb great forces. Due to the manufacture according to the method of the present invention, the compressor housing has a high stability so that these requirements are fulfilled. Advantageously, at least one reinforcement rib is integrally formed on the plastic housing and extends across two joined plastic components of the housing. The contact surfaces between the individual sections of the reinforcement rib are preferably joined to each other by means of hot gas welding so that a stable continuous reinforcement rib is formed. The reinforcement rib can however also be joined by means of electromagnetic resistance welding. By one or preferably several reinforcement ribs, increased stiffness is imparted to the compressor housing, which has a positive effect on the force absorption by the compressor housing. By using hot gas welding or resistance welding, the individual components of the plastic housing can be reliably joined to each other in a simple way despite the inhomogeneities of the wall thickness of the plastic components caused by the reinforcement ribs.

### BRIEF DESCRIPTION OF THE DRAWING

The invention will be explained jointly with respect to the method for manufacturing a plastic housing and the plastic housing manufactured by the corresponding method with the aid of the following Figure.

FIG. 1 shows schematically a section of a compressor housing of an exhaust gas turbocharger.

### PREFERRED EMBODIMENT OF THE INVENTION

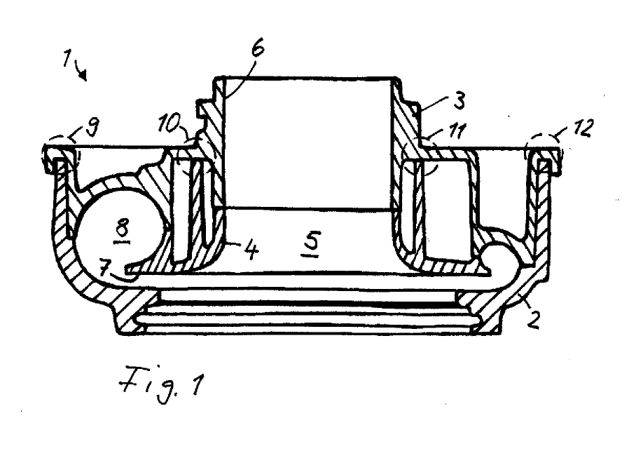

In FIG. 1 a compressor housing for a radial compressor of an exhaust gas turbocharger is illustrated. The housing 1 is comprised of three plastic components 2, 3, 4. The plastic components 2, 3, 4 are, for example, injection-molded parts. The plastic components 2, 3, 4 are comprised at least partially of a thermoplastic material.

The plastic component 2 forms a compressor back wall, the plastic component 3 forms a compressor front part, and the plastic component 4 forms a casing with a compressor wheel receptacle 5 for receiving a compressor wheel. Gas to be compressed is axially supplied to the compressor wheel through an intake socket 6 which is formed within the compressor front part. After compression, the gas is guided radially by means of a diffuser 7 into a spiral-shaped compressor passage 8 which is delimited by the compressor front part 3 and the compressor back wall 2 and opens into an outlet socket by means of which the compressed combustion air is finally supplied to the cylinders of an internal combustion engine.

The plastic component 3 is joined with the plastic component 2 by means of the first circumferentially extending weld seam wherein welding is realized by a contact surface of the two plastic components 2, 3, respectively. Moreover, the plastic component 3 is connected with the plastic component 4 by means of a second circumferentially extending weld seam. The welding zones are indicated in the Figure by circles wherein 4 welding zones result due to the section illustration. The welding zones 9 and 12 are correlated with the first weld seam, the welding zones 10 and 11 with the second weld seam. In the illustrated example, the contact surfaces are of an annular shape and are positioned in the same plane or adjoin at least approximately a common plane.

Joining the plastic components 2, 3, 4 for configuring the housing 1 is done by a hot gas welding process or by an electromagnetic resistance welding process. Welding in the welding zones 9, 10, 11, 12 can be realized simultaneously by means of hot gas welding. It is also conceivable to utilize hot gas welding for a first joining zone and resistance welding for a second joining zone. In the hot gas welding process, the plastic components 2, 3, 4 are plasticized contactless by hot gas and are joined under pressure. An oxidation of the melt during plastification is almost completely avoidable, for example, by use of nitrogen as an inert gas. For electromagnetic resistance welding a metallic heating element is placed onto at least one of the contact surfaces, inserted into a groove, or introduced into the component. The heating element is a passive heating element which is heated contactless by means of electromagnetic energy. The heating element is embodied, for example, as a wire or stamped part. The contour of the heating element is matched to the contour of the contact surface. In the illustrated case of annular contact surfaces, the heating element has also a ring shape.

The plastic components 2, 3, 4 can have a constant wall thickness or sections with different wall thickness. This is an advantage relative to a connection by means of ultrasonic welding where cross-sectional steps are to be avoided in order to prevent fracture formation. For example, on one or several of the plastic components 2, 3, 4, one or several reinforcement ribs can be integrally formed. The reinforcement ribs can extend also across several plastic components 2, 3, 4 wherein their contact surfaces are welded like the other contact surfaces.

In a variant that is not illustrated, the weld seam geometry is at least partially three-dimensional. The contact surfaces of two plastic components are then at least partially not within the same plane. In this context, the contact surfaces may also be curved. Welding along three-dimensional contours is possible without problem by a hot gas welding process or electromagnetic resistance welding process.

While specific embodiments of the invention have been shown and described in detail to illustrate the inventive principles, it will be understood that the invention may be embodied otherwise without departing from such principles.

What is claimed is:

1. A method for manufacturing a plastic housing, the method comprising:
joining at least two contact surfaces of at least two plastic components with each other by a welding process selected from the group consisting of hot gas welding; electromagnetic resistance welding; and hot gas welding and electromagnetic resistance welding.

2. The method according to claim 1, performing the welding process along at least one two-dimensional contour.

3. The method according to claim 1, performing the welding process along at least one three-dimensional contour.

4. The method according to claim 1, generating at least two weld seams in a single working step of the welding process.

5. The method according to claim 1, applying at least one metallic heating element onto at least one contact surface for electromagnetic resistance welding.

6. The method according to claim 1, introducing at least one metallic heating element into at least one contact surface for electromagnetic resistance welding.

7. The method according to claim 1, employing nitrogen in hot gas welding.

8. A plastic housing manufactured by the method of claim 1.

9. The plastic housing according to claim 8, embodied as a compressor housing for a turbocharger.

10. The plastic housing according to claim 8, wherein the plastic housing comprises at least one reinforcement rib extending across at least one joining zone between the at least two plastic components of the plastic housing.
